(19) United States
(12) Patent Application Publication
(10) Pub. No.: US 2006/0279039 A1
(43) Pub. Date: Dec. 14, 2006

(54) Grip accessory device for a portable video game

(75) Inventors: Michael Krieger, Miami Beach, FL (US); Kevin Ellsworth, Alva, FL (US)

Correspondence Address: VENABLE LLP, P.O. BOX 34385, WASHINGTON, DC, 20043-9998, US

(73) Assignee: Vector Products, Inc., Ft. Lauderdale, FL (US)

(21) Appl. No.: 11/371,956

(22) Filed: Mar. 10, 2006

Related U.S. Application Data
(60) Provisional application No. 60/659,940, filed on Mar. 10, 2005.

(51) Int. Cl. A63F 9/24; A63F 13/00; A63F 13/02

(52) U.S. Cl. 273/148 B; 463/36; 463/37

(57) ABSTRACT

A grip accessory device for an attachable portable video game has an integrated housing having opposing grip portions and a cavity for at least partially enclosing the portable video game, when the video game is placed in the housing. The grip portions of the housing are ergonomically shaped for comfort and control during play, and the cavity provides for easy, secure and robust positioning of the portable video game in the grip accessory device. In one embodiment of the invention, the grip portions define at least part of the cavity formed on the housing.

### BACKGROUND

In May, 2004, Sony Computer Entertainment Inc. announced the product specifications for its latest handheld video game called PlayStation®Portable (herein after referred to as the PSP video game). According to Sony, the PSP video game is designed to be “played anytime, anywhere.”

FIG. 1 shows the PSP video game, which according to the specification, has a 16:9 widescreen TFT LCD centered in an ergonomic design that fits in the hands. The PSP video game dimensions are 170 mm×74 mm×23 mm with a weight of 260 g. The TFT LCD display supports full color (16.77 million colors) on a 480×272 pixel high-resolution screen. The PSP video game also has built-in stereo speakers, exterior headphone connector, brightness control and sound mode selection. The keys and controls of the PSP video game have the same operability as the older models PlayStation® and PlayStation 2.

The PSP video game also includes input/output functionalities such as USB port, and 802.11b (Wi-Fi) wireless LAN. These features provide connectivity with various devices in the home and to the wireless network for online gaming, or for connecting multiple PSP video games to each other. In addition, software and data can be downloaded through the USB or wireless network onto a Memory Stick™ PRO Duo.

PSP video game uses a compact optical storage medium called Universal Media Disc(UMD™). The UMD, which is only 60 mm in diameter, can store up to 1.8 GB of digital data. As such, the UMD can be used for storage of game software having full-motion video and other forms of digital entertainment content, such as music video clips, movies and sports programs. The PSP video game also includes accessory power terminals that interface with an external power accessory device, such as a charger, etc.

Various video game accessory vendors, such as Intec Inc. (www.IntecGamer.com), Mad Catz Interactive, Inc. (www.madcatz.com), and Nyko (www.nvko.com), have announced accessories that support the PSP video game. Such accessories include protective cases, docking stations, power adapters, and starter kits. For example, in order to protect PSP video games, carrying cases are offered in a variety of sizes, which are specifically designed for carrying the UMD format discs.

Accessory power solutions for the PSP video game include AC adapters for home use and DC adapters for vehicle use. Under one arrangement, such power adapters can be used with a docking station that works as a powering center while keeping the unit secure on the user's desk.

Also known is a power charger accessory for the PSP video game includes an aluminum case with neoprene lining that snaps the game system inside a clamshell case design. The base of the charger case has battery cells, and the case itself can be plugged in and charged by an external power source. When the PSP video game is placed in the case, the user can plug in a DC plug for charging the PSP video game. The case itself holds enough power to fully charge the PSP video game three times.

Still another PSP video game accessory is called the Theater Experience PSP. This accessory is similar in design to the above described charger case. It features a stand and a pair of stereo speakers for watching movies on the PSP video game. Like the charger case, the Theater Experience has a battery cell in the base that can charge the PSP video game up to three full times.

It has been recognized that players of potable video gamers, such as Nintendo's Game Boy®, could experience discomfort, such as hand cramps, during long and extended play sessions. A soft rubber video game grip system called Ergo Grips has been used to add comfort and control while playing games. Also, Hip Gear (www.hipgearproducts.com) offers a grip called GBA SP Wing Grips that is clipped onto a Game Boy for a more comfortable and secure grip. Another known video game grip is GBA GAME BOY ADVANCE POWER GRIP, which includes a rechargeable battery pack that allows for “charge while you play action.” This grip device also incorporates built-in on/off speaker and vibration functions.

However, there still exists a need to improve the functionality of grip accessory devices that are used for playing portable video games.

### SUMMARY OF THE INVENTION

Briefly, according to an exemplary embodiment, a grip accessory device for an attachable portable video game comprises an integrated housing having opposing grip portions and a cavity for at least partially enclosing the portable video game, when the video game is placed in the housing. The grip portions of the housing are ergonomically shaped for comfort and control during play, and the cavity provides for easy, secure and robust positioning of the portable video game in the grip accessory device. In one embodiment of the invention, the grip portions define at least part of the cavity formed on the housing.

The grip accessory device is another exemplary embodiment includes a power compartment coupled to or integrated within the housing for powering/charging the portable video game. The power compartment can be a battery compartment for placing one or more batteries that are used to extend the runtime of the portable video game. As such, the power compartment has power contacts that electrically connect to a power interface port disposed within or on the housing in order to interface the power compartment with the attached portable video game. The power interface port electrically connects the power contacts of the power compartment to the accessory power terminals of the portable video game when the portable video game is placed in the housing of the grip accessory of the invention. In a further exemplary embodiment, the grip accessory device includes a transmitter transmits audio generated by the portable video game to an external receiver. The grip accessory device can additional include a display that displays information to the user of the portable video game, for example power or charge related information.

Optionally, the grip accessory device of the invention includes a cigarette lighter adapter (CLA) plug coupled to the power compartment to provide an external supply from a vehicle that complements the powering/charging of the portable video game. Further, a support stand provides support for the grip device of the invention. The grip accessory device could further include a fan disposed in the housing and the grip portions include apertures acting as air vents for the air generated by the fan to cool user's hand.

### BRIEF DESCRIPTION OF DRAWINGS

FIG. 1 shows a portable video game.

FIG. 2 shows a grip accessory device according to an exemplary embodiment of the present invention.

FIG. 3 shows the video game of FIG. 1 being attached to the grip accessory device of FIG. 2.

FIGS. 4-6 show various embodiment of the grip accessory device according to the present invention.

FIG. 7 shows an exemplary block diagram of the accessory device of the present invention.

### DETAILED DESCRIPTION OF THE INVENTION

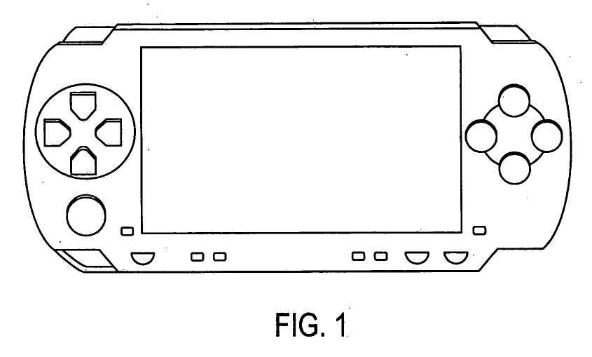

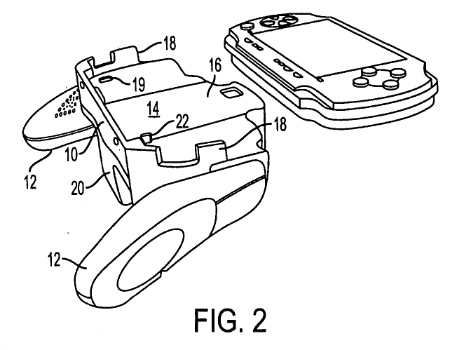

FIG. 2 shows an exemplary diagram for an ergonomically designed grip accessory device according to one embodiment of the present invention. In the exemplary embodiment, the grip accessory device is attachable to a portable video game, such as the one shown in FIG. 1. However, the present invention can be used with any type of suitable portable video game.

The grip accessory of this embodiment of the invention comprises a housing 10 having opposing grip portions 12 and a cavity 14, as shown. The cavity 14 may be formed by any unfilled or hollowed out space within the housing that extends on the sides or around the edges of the attached video game. In the exemplary embodiment, the cavity at least partially encloses the video game to provide a secure resting place for the portable video game. In the embodiment of FIG. 2, the resting place for the portable video game is provided by a support back wall 16 and side walls that form raised lips 18. The cavity 14 is formed around the sides, top and bottom periphery of the main body portion of the housing for a “slide in” or “snap” attachment of the portable video game to the grip accessory device. When attached, the audio from the portable video game is inputted to the grip accessory device via a suitable audio port 19, such as an audio plug, socket or jack. In this embodiment, the audio port is an audio jack disposed in the cavity of the housing, which is inserted into a complementary socket on the video game when it is slid into the cavity 14.

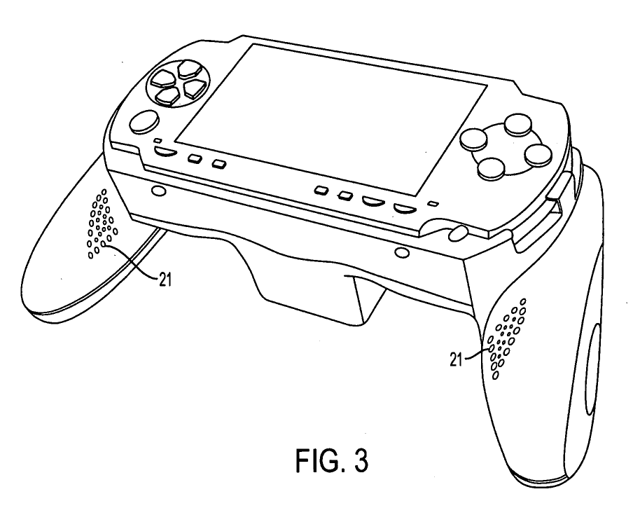

FIG. 3 shows the portable video game of FIG. 1 being placed in the cavity of the grip accessory device of FIG. 2. The grip accessory device is equipped with internal speakers 21 that are coupled to the audio port for audio interface with the user via suitable audio control circuitry. The accessory device also includes a power compartment 20 that is coupled to or integrated within the housing 10. The power compartment 20 houses one or more rechargeable batteries that extend the runtime of the portable video game by externally powering or charging the portable video game. The battery compartment has one or more power contacts that connect to a power interface port 22 disposed within or on the cavity 14 of the housing 10, as shown in FIG. 2. The power interface port 22 electrically connects the power contacts of the power compartment to the power terminals of the portable video game when the portable video game is placed, slid or snapped into the cavity, as shown in FIG. 3.

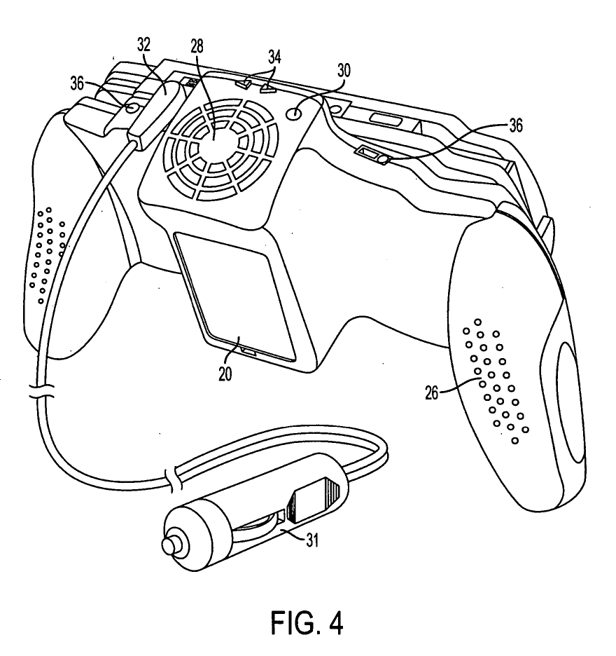

FIG. 4 shows the grip accessory device from a bottom side angle. As shown, the opposing grip portions 12 form “wing grip” portions that protrude from the housing 10 for easy grasp by a user. The grip portions on 12 are designed to be held by the user in a way that enhances control over the interface keys and buttons of the portable video game. In an exemplary embodiment, the grip portions comprise molded handle rubberized grip. The opposing wing grip portions have small apertures 26 that function as air vents for air generated by a fan 28 having an intake vent to cool or dry player hands. A player activated switch 30 is used to turn the fan on or off.

The housing 10 also includes a charge port 32 for recharging the portable video game and/or the grip device batteries in the power compartment 20. The charge port can be used to plug a AC or DC power supply, such as a cigarette lighter adapter or a AC wall cube 31. The grip device under this embodiment of the invention also includes various access ports for supporting suitable port interface requirements.

Audio control knobs/buttons 34 allow for control audio volume, the level of which could be presented to the user via the display. In one embodiment, the internal speakers 21 are disposed on the grip portions of the housing as shown in FIG. 3. Additionally, the grip device includes auxiliary audio ports 36, such as primary and secondary audio outputs, for wired interface with various external audio units, such as an audio receiver, amplifiers, etc.

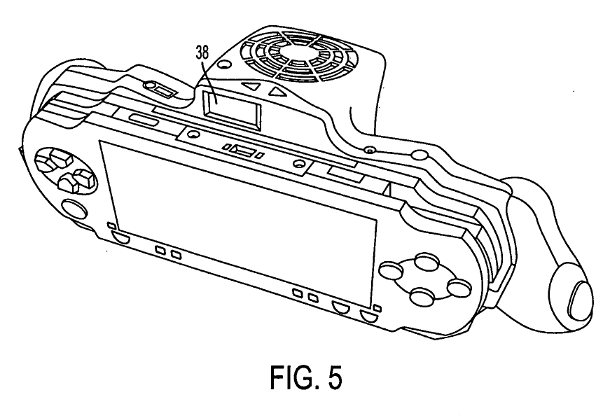

The grip accessory device also allows for audio from the video game to be communicated to an external audio receiver without wires. As such, the grip device includes an internal transmitter (not shown) for transmitting radio frequency signals that are modulated by the video game audio to be received by an external radio receiver, such as an AM, FM, or satellite band receiver, which is tuned to a transmit frequency or transmit channel supported by the transmitter. The housing 10 of the grip accessory device encloses the circuitry that receives portable video game audio form audio port 19 (shown in FIG. 2) and modulates carrier signals, preferably, within the commercial band, e.g., AM, FM, S-band. Besides the video game audio, the audio that modulates the carrier signal can be provided by other types of external audio source, e.g., an MP3 player, via an external audio port (not shown). A display 38 disposed on the housing is used to provide a user interface for setting a desired frequency channel from among a set of channels, as shown in FIG. 5. Besides the interface function, the display could be used to show various information to the user, such as charge state of the grip device batteries or the portable game device. Additionally, a protective screen can be flipped over the portable video game to provide glare protection as well as protection from scratch and dust.

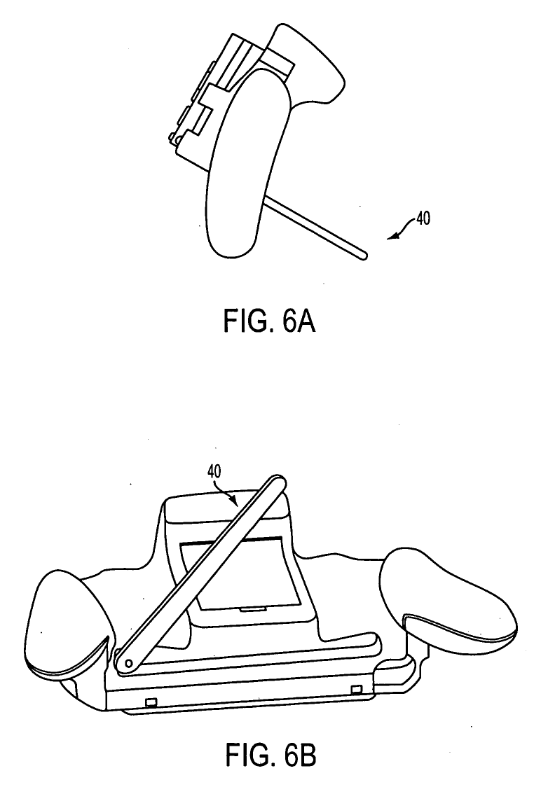

FIG. 6 shows a further embodiment of the invention where the grip accessory device of the invention includes a stand 40 for providing support. The stand 40 is a “Flip-out” or “kick” stand, which is pivotally attached to the housing 10 to so that it can be manipulated by the user for creating a suitable support for the grip accessory device.

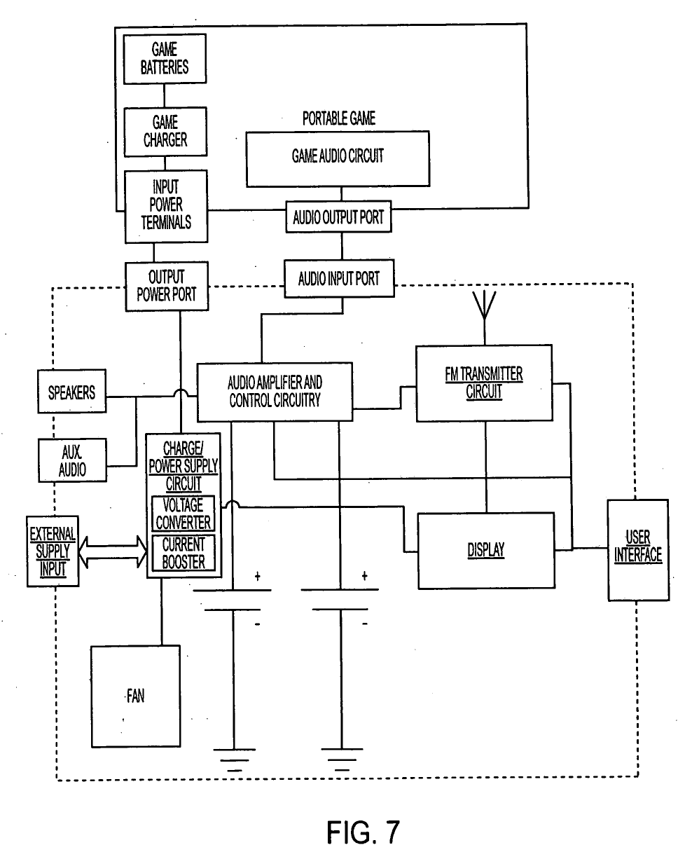

Referring to FIG. 7, a block diagram of the grip accessory device of the present invention is shown. The grip accessory device includes one or more rechargeable batteries that are enclosed within the housing. Among other things, the batteries are used to extend the play time for the video game. The grip accessory device further includes a charge port interface connector that is used to charge the one or more rechargeable batteries by an external power supply, such as cigarette lighter adapter of AC wall cube. The external power source provides the energy for charging the batteries through a charge circuit. The grip device includes an audio port for receiving videogame audio signal, when the video game is attached. The audio signal is applied to audio control circuitry for, which can selectively couple the video game audio signal to internal speakers disposed in the grip device, an FM transmitter or auxiliary audio ports. When applied to internal speakers, the video game audio can be controlled by volume control user interfaces, e.g., knobs, buttons, etc. Via the auxiliary audio ports, the video game audio signal can be provided to external audio device, such as an audio receiver or amplifier.

The grip device also has a transmitter, such as FM or satellite transmitter, that is powered by the rechargeable batteries to modulate video game audio received via the audio port on a carrier frequency. The generated audio modulated radio frequency signal is radiated via a transmit antenna for reception by a radio receiver, e.g., FM or satellite receiver, having a receive antenna for receiving broadcast audio signals. A frequency channel switch is used for selection a suitable transmit frequency channel.

Further, the accessory device of the present invention may include a display for displaying information to a user. A user interface can be used to allow the user to interface with the grip accessory device via the display. An example of such user interface could be displaying power or charge information or volume control information, or transmit channel information. FIG. 7 shows a block called user interface that is responsible for all user interface function including transmit channel selection and volume control.

From the foregoing description, it would be appreciated that the grip accessory device of the present invention improves the experience of players of portable video games by an ergonomically shaped design that provides comfort and control during the game. The cavity arrangement of the invention also makes it easier and more secure to place the portable video game in the grip accessory device.

1. A grip accessory device for an attachable portable video game that has one or more power terminals for being powered by an external power supply, comprising:
an integrated housing having opposing grip portions and a cavity for at least partially enclosing the attachable portable video game;
a power compartment having one or more power contacts;
a power interface port for electrically connecting the one or more power contacts of the power compartment to the one or more power terminals of the portable video game when the portable video game is placed in the cavity;
a transmitter that transmits audio generated by the portable video game to an external receiver; and
a display that displays information to user of the portable video game.

2. The grip accessory device of claim 1 further comprising a CLA plug coupled to the power compartment for providing external power.

3. The grip accessory device of claim 1, wherein the power compartment comprises a battery compartment.

4. The grip accessory device of claim 1, wherein the opposing grip portions at least partially define the cavity.

5. The grip accessory device of claim 1, wherein the power compartment is coupled to or integrated within the housing.

6. The grip assembly device of claim 1, wherein the power interface port is positioned within the cavity.

7. A grip accessory device for an attachable portable video game that has one or more power terminals for being powered by an external power supply, comprising:
an integrated housing having opposing grip portions for using the attachable portable video game;
a power compartment having one or more power contacts; and
a power interface port for electrically connecting the one or more power contacts of the power compartment to the one or more power terminals of the portable video game; and
a transmitter that transmits audio generated by the portable video game to an external receiver.

8. The grip accessory device of claim 7 further comprising a support stand.

9. The grip accessory device of claim 7 further comprising a display.

10. The grip accessory device of claim 7, wherein the opposing grip portions comprise wing portions.

11. The grip accessory device of claim 1 further including a fan disposed in the housing, wherein the grip portions include apertures acting as air vents for the air generated by the fan.

12. A grip accessory device for an attachable portable video game that has one or more power terminals for being powered by an external power supply, comprising:
an integrated housing having opposing grip portions for using the attachable portable video game;
a power compartment having one or more power contacts; and
a power interface port for electrically connecting the one or more power contacts of the power compartment to the one or more power terminals of the portable video game; and
a display that displays information to the user of the portable video game.

13. The grip accessory device of claim 1, wherein display is used to display power information.

14. The grip accessory device of claim 13, wherein the power information comprises battery charge information.

15. The grip accessory device of claim 12 further including a transmitter, wherein the display is used to indicate transmit channel information.
